(19) United States
(12) Patent Application Publication
(10) Pub. No.: US 2009/0322672 A1
(43) Pub. Date: Dec. 31, 2009

(54) INTERACTIVE DISPLAY

(75) Inventor: Vincentius Paulus Buil, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/524,869

(22) PCT Filed: Jan. 25, 2008
(86) PCT No.: PCT/IB0208/050276

§ 371 Date: Jul. 29, 2009

(30) Foreign Application Priority Data
Jan. 29, 2007 (EP) 071012850.0

(51) Int. Cl. G09G 5/00

(52) U.S. Cl. 345/156

(57) ABSTRACT

An interactive display (1) comprising a display area (2) for displaying first information for a user is provided with a rim area (3) for detecting second information originating from the display area (2) via an object (20) for determining a position of the object. The rim area (3) may comprise a sensor (31-50) for detecting the second information that may comprise light originating from the display area (2). The rim area (3) may further comprise a lens (51-70) for focusing the light on the sensor (31-50). The lens (51-70) maybe a lenticular and/or cylindrical and/or convex lens. The object (20) comprises a reflector (21) for reflecting the second information from the display area (2) to the rim area (3). A device (100) comprises an interactive display (1) and a controller (101) for controlling the interactive display (1) for defining a part of the display area (2) from which part the second information originates and/or for defining a frequency and/or time-dependency and/or intensity of the second information.

### FIELD OF THE INVENTION

The invention relates to an interactive display comprising a display area for displaying first information for a user.

Examples of such an interactive display are interactive liquid crystal displays, interactive light emitting diode displays and other interactive screens and interactive panels.

### BACKGROUND OF THE INVENTION

US 2003/0156100 A1 discloses in its title a display system and discloses in its FIG. 1 an interactive display comprising a display area with pixels and light sensors. The pixels are used for providing information relating to an object relative to the display and the light sensors are used to detect light produced by the display and reflected via the object. The information relating to the object relative to the display may be provided by correlating an amount of detected light from a plurality of light sensors to information relating to the object.

This display system has a relatively complex construction owing to the fact that pixels and sensors are to be combined in the display area.

### SUMMARY OF THE INVENTION

It is desirable to provide an interactive display with a relatively simple construction.

A first aspect of the invention provides an interactive display comprising a display area for displaying first information for a user and comprising a rim area for detecting second information originating from the display area via an object for determining a position of the object. By using a display area for displaying first information to be presented to a user as well as for generating second information to be detected for a determination of a position of an object, and by using a rim area for a detection of the second information, the display area still has a presentation function as well as a generation function, but the detection function has been shifted to a rim area located outside the display area. As a result, in terms of the prior art, the sensors are no longer located between the pixels, and the interactive display no longer has a relatively complex construction.

The object may be a body part of a user or may be a separate item to be held and/or moved by a user and/or a machine. The object may be used for touching the display or may be used close to the display without touching it. The first and second information may be identical information or may be partly different information by letting the first (second) information form part of the second (first) information or may be completely different information by multiplexing the first and second information for example in time and/or frequency.

According to an embodiment, the interactive display is defined by the rim area comprising a sensor for detecting the second information that comprises light originating from the display area. More than one sensor is not to be excluded. The sensor may be a photo sensor such as an entire charged coupled device chip or a part thereof that is capable of at least detecting light in the centre of the sensor or left or right from the centre. Preferably, at least two rims will each comprise one or more sensors.

According to an embodiment, the interactive display is defined by a plane of the sensor and a plane of the display area making an angle between 45 degrees and 135 degrees. Preferably, an angle between a plane of the sensor and a plane of the display area will be between 45 and 135 degrees, further preferably between 60 and 120 degrees, yet further preferably between 80 and 100 degrees and ideally 90 degrees.

According to an embodiment, the interactive display is defined by the rim area further comprising a lens for focusing the light on the sensor. A lens placed in front of a sensor or in front of a part of the sensor or in front of a group of sensors will increase a performance of the sensor(s) and will increase a number of different detections.

According to an embodiment, the interactive display is defined by the lens comprising at least a part of a lenticular and/or cylindrical and/or convex lens. For example with a convex lens, it could be measured how high an object is held above the display. This may require the processing of the light falling on the sensor(s) in two directions.

A second aspect of the invention provides an object for use in combination with the interactive display as defined above, which object comprises a reflector for reflecting the second information from the display area to the rim area. Preferably, at least a part of a reflector will be situated in a plane that makes an angle with a plane of the display area and/or with a plane of the sensor(s) between 30 and 60 degrees, further preferably between 40 and 50 degrees and ideally 45 degrees. Alternatively the reflector can be curved, for example via a demi-sphere at the bottom of a cylindrical object, to increase a chance, for example in case the object is being tilted, that at least some of the light from the display is directed to the sensor(s).

A third aspect of the invention provides a device comprising the interactive display as defined above, with or without an object.

According to the present invention, a controller is provided for controlling the interactive display for defining a part of the display area from which part the second information originates and/or for defining a frequency and/or a time-dependency and/or an intensity of the second information. By generating the second information from a part of the display area only and/or from different parts of the display area one after the other, a position of the object can be checked. By defining a frequency and/or a time-dependency and/or an intensity of the second information, a reliability of a detection can be improved and/or a difference between the first and second information can be introduced and/or increased.

A fourth aspect of the invention provides a method for determining a position of an object via an interactive display comprising a display area and a rim area, which method comprises the steps of via the display area displaying first information for a user and via the rim area detecting second information originating from the display area via the object.

A fifth aspect of the invention provides a computer program product for performing the steps of the method as defined above and/or a medium for storing and comprising the computer program product.

Embodiments of the device, the method, the computer program product and the medium correspond with the embodiments of the interactive display.

An insight might be, that locating pixels and sensors in one and the same display area is relatively complex. A basic idea might be, that a display area is to be used for displaying and generating information and that a rim area is to be used for detecting the information via an object for determining a position of the object.

A problem to provide an interactive display having a relatively simple construction is solved. A further advantage of the interactive display might be, that its resolution is no longer limited by a presence of sensors between pixels.

These and other aspects of the invention are apparent from and will be elucidated with reference to the embodiments described hereinafter.

### BRIEF DESCRIPTION OF THE DRAWINGS

In the drawings:

FIG. 1 shows a top view of an interactive display according to the invention and an object according to the invention,

FIG. 2 shows a side view of an object according to the invention in relation to planes of the interactive display according to the invention,

FIG. 3 shows a top view of a part of an interactive display according to the invention and an object according to the invention and projections of light reflected via the object,

FIG. 4 shows a 3D view of an object according to the invention in relation to planes of the interactive display according to the invention and reflections of light reflected via the object,

FIG. 5 shows a schematic diagram of a device according to the invention comprising an interactive display according to the invention and a controller, and

FIG. 6 shows a side view of an object used at different heights in relation to a sensor and a lens.

### DETAILED DESCRIPTION

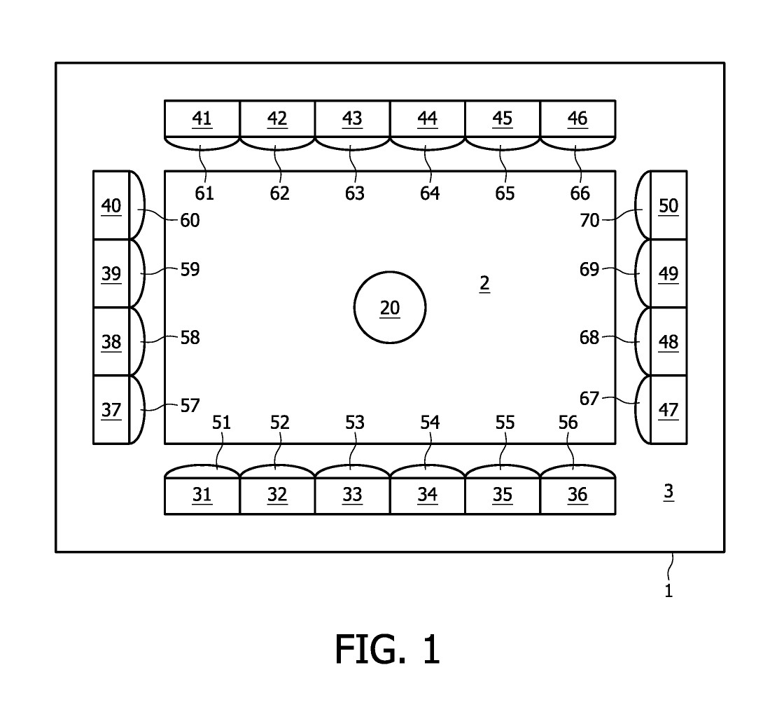

The interactive display 1 shown in the FIG. 1 in top view comprises a display area 2 (inner area) and a rim area 3 (outer area). The display area 2 for example comprises liquid crystal display parts or light emitting diodes all not shown. An object 20 is located on or closely above the display area 2. The rim area 3 comprises at a first rim for example six combinations of a sensor 31-36 and a lens 51-56 and comprises at a second rim for example four combinations of a sensor 37-40 and a lens 57-60 and comprises at a third rim for example six combinations of a sensor 41-46 and a lens 61-66 and comprises at a fourth rim for example four combinations of a sensor 47-50 and a lens 67-70.

In general, the display area 2 displays first information destined for a user and the rim area 3 detects second information originating from the display area 2 via the object 20 for determining a position of the object 20. According to an embodiment, the rim area 3 may comprise one or more sensors 31-50 for detecting the second information that comprises visible and/or non-visible light originating from the display area 2. Alternatively, the rim area may comprise one or more detectors for detecting the second information that comprises electromagnetic waves originating from the display area 2. Further, according to an embodiment, the rim area 3 may comprise one or more lenses 51-70 for focusing the light on the sensor 31-50. These one or more lenses 51-70 may comprise at least parts of lenticular and/or cylindrical and/or convex lenses. A sensor 31-50 may be a photo sensor such as a charged coupled device chip that is capable of at least detecting light in the centre of the sensor or left or right from the centre. Alternatively, each sub-sensor of a photo sensor may be considered to be a sensor 31-50. Preferably, at least two rims will each comprise one or more sensors 31-50.

A charged coupled device chip for example generates a picture. This picture is defined by digital data or is to be converted into digital data. This digital data for example defines at which location in the picture which color and/or which intensity at which time has been measured. From this digital data, possibly originating from different chips at different rims, a position of the object can be derived.

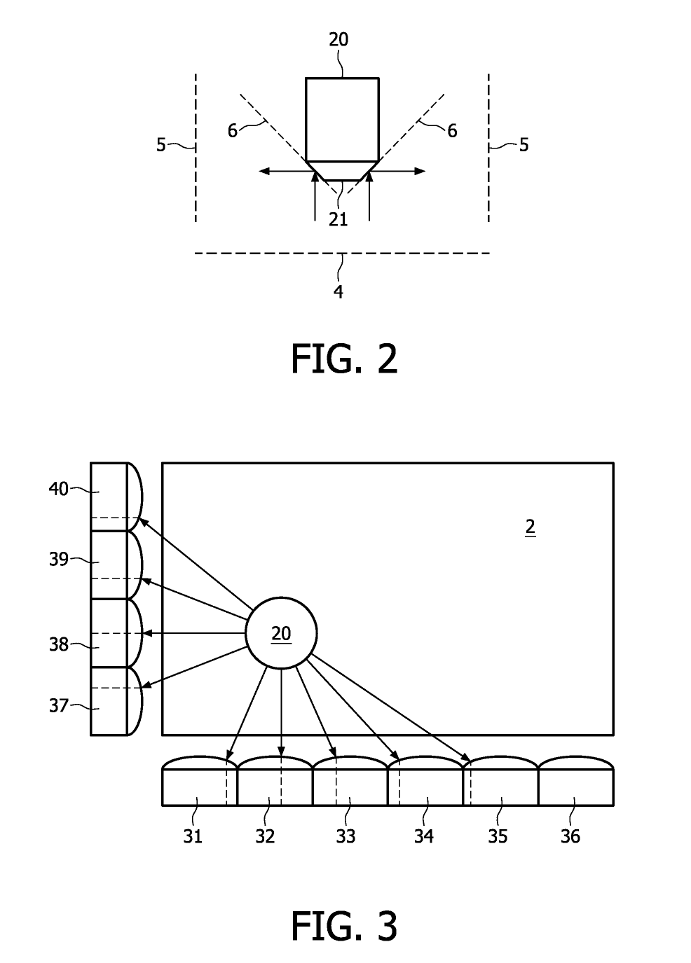

The object 20 shown in the FIG. 2 in side view comprises a reflector 21 for reflecting the second information from the display area 2 to the rim area 3. During use, according to an embodiment, at least a part of the reflector 21 will be situated in a plane 6 that makes an angle with a plane 4 of the display area and/or with a plane 5 of the sensor between 30 and 60 degrees, further preferably between 40 and 50 degrees and ideally 45 degrees. According to a further embodiment, the plane 5 of the sensor 31-50 and the plane 4 of the display area 2 will make an angle between 45 degrees and 135 degrees, preferably between 60 and 120 degrees, further preferably between 80 and 100 degrees and ideally 90 degrees. The second information may for example comprise light originating from the plane 4 and being reflected to the planes 5.

The object 20 may be a body part of a user in which case the reflector 21 may be a part to be put on the user's body part or may be a separate item to be held and/or moved by a user and/or a machine. The object 20 may be used for touching the display area 2 or may be used close to the display area 2 without touching it.

The part of the interactive display 1 and the object 20 shown in the FIG. 3 in top view correspond to corresponding parts already shown in the FIG. 1, whereby in addition light originating from the display area 2 is shown that has been reflected via the object 20 and its reflector 21. A combination of a sensor 31-50 and a lens 51-70 results in a projection of the light on a part of the sensor 31-50, which part depends on a position of the object 20 in relation to the display area 2. Alternatively, more than one sensor may be covered by a lens, or one sensor may be covered by more than one lens.

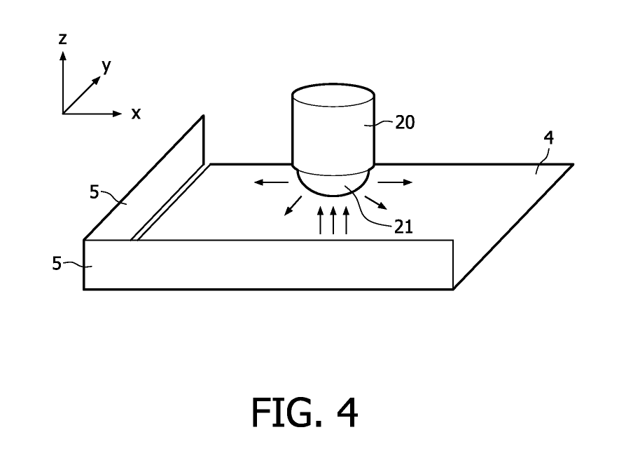

The object 20 shown in the FIG. 4 in 3D view comprises the reflector 21 that reflects the light originating from the plane 4 to the planes 5 of the interactive display. A detection of the second information in the planes 5 may be a detection in one direction (a direction such as a x-direction or a y-direction that forms part of the plane 4 and one of the planes 5) or may comprise detections in two directions (a first direction such as a x-direction or a y-direction that forms part of the plane 4 and one of the planes 5 and a second direction such as a z-direction that forms part of the plane 5 and is perpendicular to the plane 4).

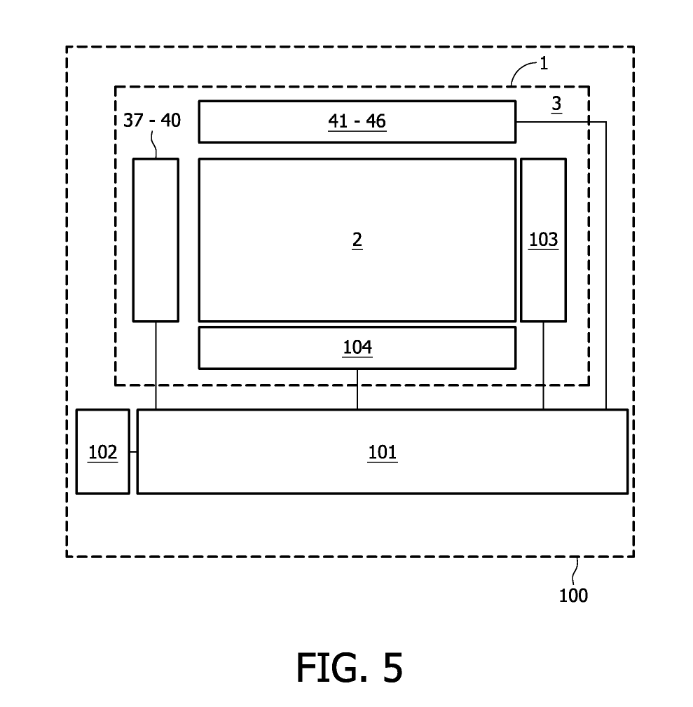

The device 100 shown in the FIG. 5 comprises an interactive display 1 with a display area 2 and a rim area 3 already shown in the FIG. 1. This time, the rim area 3 is provided with sensors 37-40 and with sensors 41-46 already shown in the FIG. 1 and further comprises a row driver 103 and a column driver 104 for driving the rows and columns of the display area 2. The device 100 further comprises a controller 7 coupled to the sensors 37-40 and 41-46 and to the drivers 103 and 104. The controller 7 is further coupled to a memory 102 and may be further coupled to a man machine interface and a network interface all not shown etc. The memory 102 may be a medium for storing and comprising a computer program product, without having excluded another kind of medium.

The controller 101 may control the interactive display 1 for defining a part of the display area 2 from which part the second information originates and/or for defining a frequency and/or a time-dependency and/or an intensity of the second information. By generating the second information from a part of the display area 2 only and/or from different parts of the display area 2 one after the other, a position of the object 20 can be checked. By defining a frequency and/or a time-dependency and/or an intensity of the second information, a reliability of a detection can be improved and/or a difference between the first and second information can be introduced and/or increased. The first and second information may be identical information or may be partly different information by letting the first (second) information form part of the second (first) information or may be completely different information by multiplexing the first and second information for example in time and/or frequency under control from the controller 101.

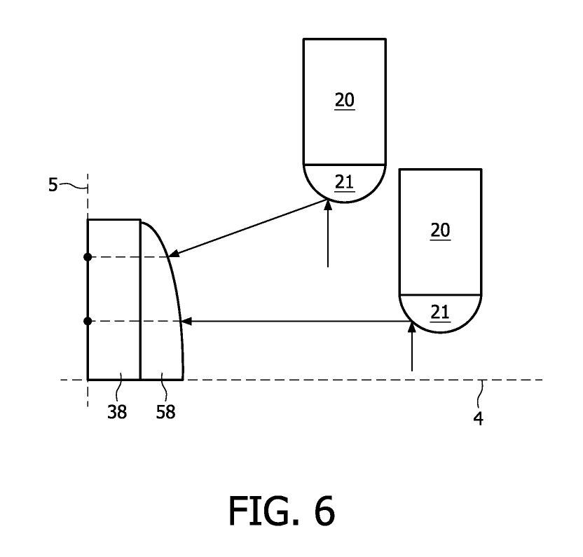

In the FIG. 6, an object 20 is used at different heights in relation to a combination of a sensor 38 and a lens 58. The use at different heights may result in different projections (in a z-direction) via the lens 58 in the sensor 38 as shown. Thereto, for example the lens may be given a special shape and/or may be made of a special material, and/or for example the reflector 21 of the object 20 may be given a special shape and/or may be made of a special material etc.

The fact that the object 20 may be used for touching the display area 2 or may be used close to the display area 2 without touching it is to be looked at as follows. When being used for touching the display area 2, the plane 5 of the sensor 31-50 and the plane 4 of the display area 2 may for example make an angle between 45 degrees and 90 degrees with each other dependently on a size and or a structure of (the reflector 21 of) the object 20. When being used close to the display area 2 without touching it, the plane 5 of the sensor 31-50 and the plane 4 of the display area 2 may for example make an angle between 90 degrees and 135 degrees with each other dependently on a size and or a structure of (the reflector 21 of) the object 20.

The interactive display 1 forms for example part of an interactive table top, such as the Philips Entertaible, and provides a solution for interacting with a display, by for example using objects as such as game pawns, or fingers and other hand parts (from multiple users if desired). A solution is proposed in which for example display light is reflected to a rim of the display via for example a 45 degrees reflective surface (mirror) of an object such as a pawn. The reflected light may be sensed by for example photo sensors behind lenticular lens arrays integrated in the rim. An advantage of this constellation is that no separate light source is needed, as the display light is used, while the measurement can be continuous without requiring a prior art full loop scan along the rim of the screen. Besides pawns, alternatively the refraction in the fingers or other body parts can be used and sensed for positioning. Color information and/or other light coding techniques produced by the screen can be used to assist in the position determination.

A possible embodiment could consist of a flat screen, with along the rim an array of photo sensors (such as for example small CCD chips), placed behind a lenticular lens array. The pawns used on the screen may have on the bottom a 45 degrees reflective surface, to reflect the light from the display to the rim of the display. The lenticular lenses will convert the direction (angle) of light received from a pawn into a position of light on the horizontal axis of the sensor. Light from a pawn straight across the lens will create a spot of light in the centre of the sensor, while light from a pawn positioned to the right (left) of the sensor will produce a spot on the right (left) side of the sensor. This relation can be used in the opposite direction (position to direction) to calculate where a pawn should be, by combining the information from all sensors. Position determination of a pawn is done by using various parameters. A first parameter may be a position of an object in the image recorded by the light sensor: Left means on the left side of the table, right means on the right side of the table. Another parameter may be a horizontal displacement between the images of the sensors as is known in stereoscopic vision and 3D photography. When positioning the left and right image next to each other, objects close to the viewer are also closer to each other in the image pair then objects further away. With this information it is possible to judge a distance of an object. A third parameter may be the light intensity and size, which can also say something about the distance of the object.

In principle it would be possible to detect a single pawn with only two CCD chips. When using multiple pawns however, occlusion would soon disrupt the measurement. Increasing the number of CCDs might be a solution when dealing with occlusion problems. The preferred embodiment would have light sensors and lenticular lenses on all four sides of the display, to enables the best view on the objects on the display, and allows for positions of a multitude of objects to be determined simultaneously. Once a position of a pawn has been determined, the system could perform a double check by using coded light. In this case the display would for example quickly flicker or change the color of the pixels underneath the pawn to see whether this corresponds with the objects on the images of the sensors.

Summarizing, an interactive display 1 comprising a display area 2 for displaying first information for a user is provided with a rim area 3 for detecting second information originating from the display area 2 via an object 20 for determining a position of the object. The rim area 3 may comprise a sensor 31-50 for detecting the second information that may comprise light originating from the display area 2. The rim area 3 may further comprise a lens 51-70 for focusing the light on the sensor 31-50. The lens 51-70 may be a lenticular and/or cylindrical and/or convex lens. The object 20 comprises a reflector 21 for reflecting the second information from the display area 2 to the rim area 3. A device 100 comprises an interactive display 1 and a controller 101 for controlling the interactive display 1 for defining a part of the display area 2 from which part the second information originates and/or for defining a frequency and/or time-dependency and/or intensity of the second information.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired and/or wireless telecommunication systems. Any reference signs in the claims should not be construed as limiting the scope.

1. An interactive display (1) comprising a display area (2) for displaying first information for a user and comprising a rim area (3) for detecting second information originating from the display area (2) via an object (20) for determining a position of the object (20).

2. An interactive display (1) as claimed in claim 1, the rim area (3) comprising a sensor (31-50) for detecting the second information that comprises light originating from the display area (2).

3. An interactive display (1) as claimed in claim 2, a plane (5) of the sensor (31-50) and a plane (4) of the display area (2) making an angle between 45 degrees and 135 degrees.

4. An interactive display (1) as claimed in claim 2, the rim area (3) further comprising a lens (51-70) for focusing the light on the sensor (31-50).

5. An interactive display (1) as claimed in claim 4, the lens (51-70) comprising at least a part of a lenticular and/or cylindrical and/or convex lens.

6. An object (20) for use in combination with the interactive display (1) as claimed in claim 1, which object (20) comprises a reflector (21) for reflecting the second information from the display area (2) to the rim area (3).

7. A controller (101) for controlling the interactive display (1) of claim 1 for defining a part of the display area (2) from which part the second information originates and/or for defining a frequency and/or a time-dependency and/or an intensity of the second information.

8. A method for determining a position of an object (20) via an interactive display (1) comprising a display area (2) and a rim area (3), which method comprises the steps of via the display area (2) displaying first information for a user and via the rim area (3) detecting second information originating from the display area (2) via the object (20).

9. A computer program product for performing the steps of the method as claimed in claim 8 and/or a medium for storing and comprising the computer program product.
